(19) United States
(12) Patent Application Publication
(10) Pub. No.: US 2024/0061911 A1
(43) Pub. Date: Feb. 22, 2024

(54) Methods and Systems for Enabling Electronic Access to Electronic Content Offerings Over a Network

(71) Applicant: Ulta Salon, Cosmetics & Fragrance, Inc., Bolingbrook, IL (US)

(72) Inventors: Antoine Zambelli, Bolingbrook, IL (US); SaiSreeTeja Amirineni, Bolingbrook, IL (US); Chatura Samarasinghe, Bolingbrook, IL (US); Michelle Pacynski, Bolingbrook, IL (US)

(21) Appl. No.: 17/891,468

(22) Filed: Aug. 19, 2022

(51) Int. Cl. G06F 21/10; G06F 16/9535; G06F 16/9536

(52) U.S. Cl. CPC G06F 21/10; G06F 16/9535; G06F 16/9536; G06F 2221/0713

(57) ABSTRACT

An example method includes dividing content into a normal set and an exclusive set, ranking content of the normal set based on a user preference vector, creating a prioritized list of tiers of content, publishing the prioritized list of tiers of content to the network and restricting access to certain tiers of the prioritized list of tiers of content, receiving a selection of a first content from a first tier (that is an unrestricted tier) associated with a first user account, determining a social engagement factor (SEF) for the first user account based on an amount of social media activity over the network associated with the first content and attributed to the first user account, and based on the SEF for the first user account, electronically enabling access to a higher priority tier of the prioritized list of tiers of content for the first user account.

### FIELD

The present disclosure relates generally to methods and systems for enabling electronic access to electronic content offerings over a network. More particularly, the disclosure relates to enabling electronic access to electronic content offerings on a tier-by-tier basis where tiers are unlocked in view of a user's social engagement factor (SEF) that informs of an amount of social media activity over the network by the user and that is associated with certain content of the electronic content offerings.

### BACKGROUND

Access to electronic content offerings over a network by users can take many forms. Traditional browsing on e-commerce websites is most popular where a user has full choice and access to any number or type of an offer via an electronic transaction. However, retailers and distributors of various electronic offerings, which can include access to electronic data or access to purchase products or services, etc., often present targeted offers to users. Targeted offers can include access to discounts, access to restricted data, or offers with other market-driven goals.

Some electronic offerings can include incentives to users for lower pricing, but user engagement in repricing systems can be low as repricing occurs implicitly and the customer has little to no control. From a retailer or distributor point of view, sales figures of content or products can increase or decrease based on social presence, and thus, social media is a strong driver of sales in online retailing and can give rise to trends, create brand awareness, and be a platform for other rise free advertising. Thus, many retailers or distributors look to engage users more effectively through social media offerings.

Gaming has also become a trend in electronic content offers such that gamification is included in many offerings. From simple quizzes to more complex systems, smartphone applications and web applications have successfully leveraged gamification to learn about users and provide personalized products and experiences.

### SUMMARY

Within examples, lists of data content are received at a server, and the server both uniquely ranks and divides the content for creation of a prioritized list of tiers of content, and then publishes the prioritized list of tiers of content to the network. However, some content or list of tiers of content can have restrictions for access. The server further utilizes unique and technical functionality to determine when to remove the restrictions, per user, based on electronic activity attributed to user accounts.

Within an example, a method of enabling electronic access to electronic content offerings over a network is described, comprising receiving at a server a list of content, dividing content of the list of content into a normal set and an exclusive set, and ranking content of the normal set based on a user preference vector. The user preference vector is determined according to data available per user accounts that is indicative of prior consumption of related content. The method also comprises creating a prioritized list of tiers of content and each tier includes a plurality of nodes populated with content from the ranked normal set at positions of the plurality of nodes dynamically determined per the user accounts and with content from the exclusive set at a static position, publishing by the server the prioritized list of tiers of content to the network and restricting access to certain tiers of the prioritized list of tiers of content, and receiving from a computing device accessing the server over the network a selection of a first content from a first tier. The first tier is an unrestricted tier and the selection is associated with a first user account. The method also comprises determining a social engagement factor (SEF) for the first user account based on an amount of social media activity over the network that is associated with the first content and is attributed to the first user account, and based on the SEF for the first user account, electronically enabling access at the server to a higher priority tier of the prioritized list of tiers of content for the first user account.

In another example, a system is described comprising one or more processors and non-transitory computer-readable media having stored therein instructions, which when executed by the one or more processors, causes the system to perform functions. The functions comprise receiving a list of content, dividing content of the list of content into a normal set and an exclusive set, ranking content of the normal set based on a user preference vector. The user preference vector is determined according to data available per user accounts that is indicative of prior consumption of related content. The functions also comprise creating a prioritized list of tiers of content and each tier includes a plurality of nodes populated with content from the ranked normal set at positions of the plurality of nodes dynamically determined per the user accounts and with content from the exclusive set at a static position, publishing the prioritized list of tiers of content to a network and restricting access to certain tiers of the prioritized list of tiers of content, and receiving from a computing device accessing the system over the network a selection of a first content from a first tier. The first tier is an unrestricted tier and the selection is associated with a first user account. The functions also comprise determining a social engagement factor (SEF) for the first user account based on an amount of social media activity over the network that is associated with the first content and is attributed to the first user account, and based on the SEF for the first user account, electronically enabling access at the system to a higher priority tier of the prioritized list of tiers of content for the first user account.

In another example, a non-transitory computer-readable media is described having stored therein executable instructions, which when executed by a system one or more processors causes the system to perform functions. The functions comprise receiving a list of content, dividing content of the list of content into a normal set and an exclusive set, and ranking content of the normal set based on a user preference vector. The user preference vector is determined according to data available per user accounts that is indicative of prior consumption of related content. The functions also comprise creating a prioritized list of tiers of content and each tier includes a plurality of nodes populated with content from the ranked normal set at positions of the plurality of nodes dynamically determined per the user accounts and with content from the exclusive set at a static position, publishing the prioritized list of tiers of content to a network and restricting access to certain tiers of the prioritized list of tiers of content, and receiving from a computing device accessing the system over the network a selection of a first content from a first tier. The first tier is an unrestricted tier and the selection is associated with a first user account. The functions also comprise determining a social engagement factor (SEF) for the first user account based on an amount of social media activity over the network that is associated with the first content and is attributed to the first user account, and based on the SEF for the first user account, electronically enabling access at the system to a higher priority tier of the prioritized list of tiers of content for the first user account.

The features, functions, and advantages that have been discussed can be achieved independently in various examples or may be combined in yet other examples. Further details of the examples can be seen with reference to the following description and drawings.

### BRIEF DESCRIPTION OF THE FIGURES

Examples, objectives and descriptions of the present disclosure will be readily understood by reference to the following detailed description of illustrative examples when read in conjunction with the accompanying drawings, where the following drawings illustrate examples as described below.

FIG. 1 is a block diagram illustrating an example of a networked computer system, according to an example implementation.

FIG. 2 illustrates a block diagram of an electronic content offering platform, according to an example implementation.

FIG. 3 illustrates a simplified block diagram of the client device, according to an example implementation.

FIG. 4 illustrates a simplified block diagram of the host server device, according to an example implementation.

FIG. 5 is a flowchart illustrating an example of a computer-implemented method for enabling electronic access to electronic content offerings over a network, according to an example implementation.

FIG. 6 conceptually illustrates an example of creation of tiers of products, according to an example implementation.

FIG. 7 is an example screenshot of the GUI on the client device operated for functionality of the electronic content offering platform including notifying the client device of a new campaign, according to an example implementation.

FIG. 8 is another example screenshot of the GUI on the client device operated for functionality of the electronic content offering platform including providing information of the campaign, according to an example implementation.

FIG. 9 is another example screenshot of the GUI on the client device operated for functionality of the electronic content offering platform including publishing the content offerings, according to an example implementation.

FIG. 10 is another example screenshot of the GUI on the client device operated for functionality of the electronic content offering platform including receiving a selection of an item of the campaign, according to an example implementation.

FIG. 11 is another example screenshot of the GUI on the client device operated for functionality of the electronic content offering platform including the server determining points for the user account, according to an example implementation.

FIG. 12 is another example screenshot of the GUI on the client device operated for functionality of the electronic content offering platform including prompting the user to checkout, according to an example implementation.

FIG. 13 is another example screenshot of the GUI on the client device operated for functionality of the electronic content offering platform including illustrating all products pledged by the user, according to an example implementation.

FIG. 14 is another example screenshot of the GUI on the client device operated for functionality of the electronic content offering platform including the server awarded points to the user, according to an example implementation.

FIG. 15 is another example screenshot of the GUI on the client device operated for functionality of the electronic content offering platform including the server illustrating achievements completed by the user for accomplishing certain tasks, according to an example implementation.

FIG. 16 is an example graph illustrating dynamics between two affinity clusters, according to an example implementation.

FIG. 17 is a flowchart illustrating another example of a computer-implemented method for enabling electronic access to electronic content offerings over a network, according to an example implementation.

### DETAILED DESCRIPTION

Disclosed examples will now be described more fully hereinafter with reference to the accompanying drawings. Several different examples are described and should not be construed as limited to all possible alternatives. Rather, these examples are described so that this disclosure is thorough and complete and fully conveys a scope of the disclosure to those skilled in the art.

Within examples, systems and methods described herein are beneficial for enabling electronic access to electronic content offerings over a network, such as via a graphical user interface (GUI).

Implementations of this disclosure provide technological improvements that are particular to computer technology, for example, those concerning data processing, data routing, computer graphical representation, and product data analysis. Computer-specific technological problems, such as creating a prioritized list of tiers of content where each tier includes a plurality of nodes populated with content from discrete sets of content at positions of the plurality of nodes either dynamically determined per user accounts or based on static positions, can be wholly or partially solved by implementations of this disclosure. For example, implementation of this disclosure allows for many types of content offerings indicative of or including information corresponding to merchandise information to be processed for publication by the server to the network such that access to certain tiers of the prioritized list of tiers of content is restricted per user accounts.

Implementations of this disclosure thus introduce new and efficient improvements in the ways in which products, services, and other content offerings are made available to user accounts over the network. The implementations of the present disclosure also introduce new and efficient improvements in the ways that the server makes determinations for enabling electronic access to the content offerings over the network per user account.

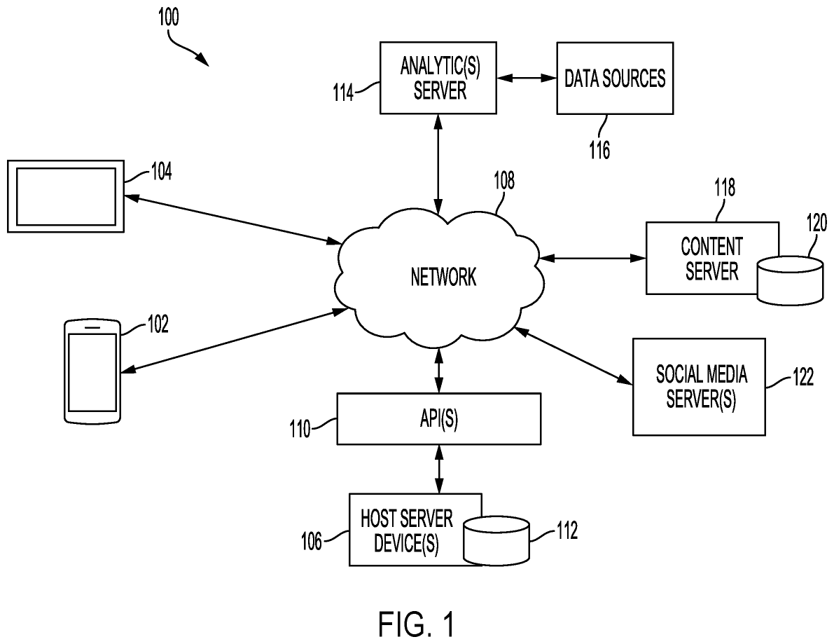

Referring now to the figures, FIG. 1 is a block diagram illustrating an example of a networked computer system 100, according to an example implementation. The networked computer system 100 includes one or more client devices 102 and 104 coupled to one or more host server device(s) 106 via a network 108. The network 108 represents one or more local area networks (LANs), wide area networks (WANs), cellular networks, and/or other networks using any of wired, wireless, terrestrial microwave, or satellite links, and may include the public Internet.

The client devices 102 and 104 can be a special purpose data processor, a general-purpose computer, smartphone, tablet, a computer system, or a group of networked computers or computer systems configured to perform steps or modes of methods described herein. Further examples of the client devices 102 and 104 may include, without limitation, handheld computers, wearable devices, laptop computers, desktop computers, servers, portable media players, gaming devices, in-store kiosks, and so forth. According to one example, the client devices 102 and 104 are built on a personal computer platform, such as the Apple® or Android® platform. Although FIG. 1 illustrates two of the client devices 102 and 104, the networked computer system may include fewer or more of the client devices 102 and 104 operating at any time. The client devices 102 and 104 represent computing devices (and the terms client device and computing device are used interchangeably throughout), which can be portable in nature as described above.

The host server devices(s) 106 may include any number of computers, virtual machine instances, and/or data centers that are configured to host or execute one or more instances of host applications. The host server devices(s) 106 may be involved, directly or indirectly, in processing requests received from the client devices 102 and 104. The host server devices(s) 106 may comprise, for example, one or more of a network device, a web server, an application server, a database server, etc. A collection of the host server devices(s) 106 may be configured to implement a network-based service. For example, a provider of a network-based service may configure one or more of the host server devices(s) 106 and host applications (e.g., one or more web servers, application servers, database servers, etc.) to collectively implement a network-based application.

The client devices 102 and 104 communicate with one or more host applications at the host server devices(s) 106 to exchange information. The communication between the client devices 102 and 104 and a host application may, for example, be based on the Hypertext Transfer Protocol (HTTP) or any other network protocol. Content delivered from the host application to the client devices 102 and 104 may include, for example, HyperText Markup Language (HTML) documents, media content, etc. The communication between the client devices 102 and 104 and a host application may include sending various requests and receiving data packets. For example, the client devices 102 and 104 or an application running on the client devices 102 and 104 may initiate communication with a host application by making a request for a specific resource (e.g., based on an HTTP request), and the host server devices(s) 106 may respond with the requested content stored in one or more response packets.

Thus, one or more client applications may be executed at the client devices 102 and 104. Some applications executing at the client devices 102 and 104 may implement one or more application programming interfaces (APIs) 110. The APIs 110, for example, process inputs and control outputs of the client devices 102 and 104. For example, a client application executing at the client devices 102 and 104 accesses the host server device(s) 106 via the API 110 to retrieve configuration parameters for a particular requested skin advisor platform. The client application then uses local image processing libraries along with retrieved configuration parameters to generate visual media in response to a request by the host server device(s) 106.

The APIs 110 serve as an interface between the client devices 102 and 104 and the host server device(s) 106. One or more repositories and/or databases 112, which support certain utilities, may store content required for implementing the skin advisor platform described herein, and is accessible by the host server device(s) 106. For example, the databases 112 store host applications, content (e.g., images/video), data related to image processing (e.g., image processing libraries, computer graphics, predefined visual effects, etc.), information relevant to the users (e.g., registration information or usage statistics), metadata, and any other data used in implementing the techniques described herein.

Thus, in some examples, techniques described herein are provided by a software platform that is made accessible via a website or an application via the API 110. Alternatively, or in addition, techniques described herein are offered as a platform product directly implementable on various devices or systems.

The networked computer system 100 also includes an analytic(s) server 114. The analytic(s) server 114 performs analytics on data related to usage behavior of the networked computer system 100. Such analytics may support other services including product recommendations and targeted marketing.

The networked computer system 100 also includes one or more data sources 116 accessible by the analytic(s) server 114. The data sources 116 generally refer to any sources from which data is received to implement features described herein. As a few illustrative examples, the data sources 116 include makeup product vendors, manufacturers, retailers, etc., content providers/licensing services, modeling services, and machine generated data sources such as server log files, activity log files, configuration files, messages, network packet data, performance measurements, sensor measurements, and the like.

The networked computer system 100 also includes a content server 118. The content server 118 is in communication with the client devices 102 and 104 and the host server device(s) 106 via the network 108 to provide listings of content, such an electronic content offerings. Examples of electronic content offerings include a list including one or more of merchandise information, promotions, and discounts associated with products or items. Other examples of electronic content offerings include a list of products. Any combination of content offerings or other electronic data representing merchandise information may be included within electronic content offerings as described herein. Although one content server 118 is shown, many content servers can be in communication with the network 108 to offer various types of electronic offerings. Content servers can be associated with retailers or distributor, in which case, each retailer has a specific content server in communication with the network. The content server 118 is shown to further include a content data source 120 accessible by the content server 118 for accessing data including the electronic content offerings. The content data source 120 further stores information for user accounts, for example, such as for each retailer or distributor associated with the content server 118.

In some examples, the content server 118 outputs lists of electronic content offering to the host server device(s) 106 and/or to the client devices 102 and 104. In an example where the content server 118 outputs lists of electronic content offering to the host server device(s) 106, the host server device(s) 106 can process the lists prior to making the data available to the client devices 102 and 104.

The networked computer system 100 also includes a social media server 122. The social media server 122 enables access to websites and applications for interactive technologies that facilitate creation and sharing of information, ideas, interests, and other forms of expression through virtual communities and networks. Many types of social media servers can be used, and examples include social networking sites (e.g., Facebook®, Twitter®, and LinkedIn®), social review sites, image sharing sites, video hosting sites, community blogs, discussion sites, sharing economy networks, among others.

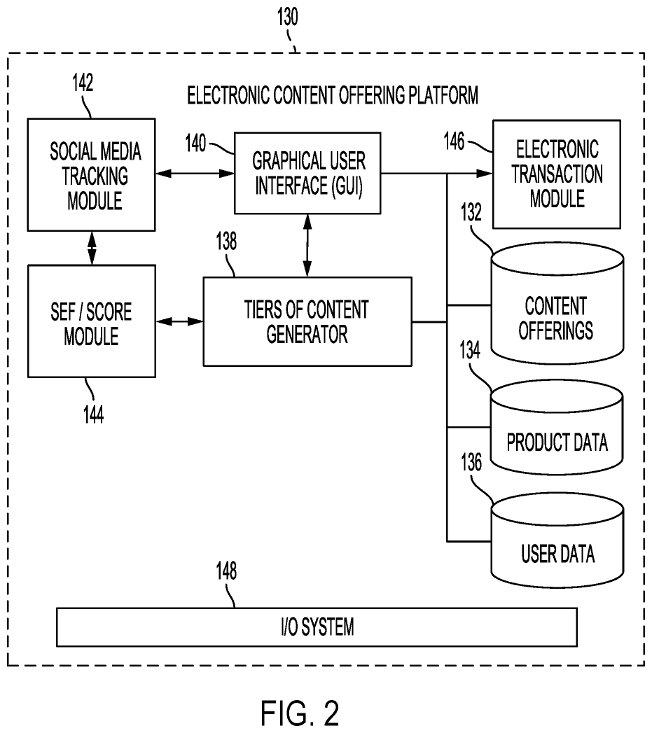

FIG. 2 illustrates a block diagram of an electronic content offering platform 130, according to an example implementation. Within examples, some or all of the components of the networked computer system 100 perform some functions of the electronic content offering platform 130. Depending upon a particular implementation, the various components described with respect to FIG. 2 are implemented at a single computing device (e.g., the host server device(s) 106 or one of the client devices 102 and 104) or distributed across several computing devices or servers. In some examples, certain functionalities of the electronic content offering platform 130 (e.g., image capture) are performed at one of the client devices 102 and 104 while other functionalities (e.g., image recognition) are performed at a remote server device. For instance, functions of a social media tracking module 142 are performed remotely at a server device in one example, and in another example, functions of the social media tracking module 142 are performed locally at the client devices 102 and 104.

With reference to FIG. 2, and throughout the disclosure, some components are described as “modules,” “engines”, or “generators” and such components include general purpose or special purpose hardware (e.g., general or special purpose processors), firmware, and/or software embodied in a non-transitory computer-readable (storage) medium for execution by one or more processors to perform described functionality.

The electronic content offering platform 130 includes or has access to databases such as a content offerings database 132, a product data database 134, and a user data database 136. The content offerings database 132 stores information and data about received content or lists of content, and content can include merchandise information, promotions, and discounts, for example. The product data database 134 includes information and data about a list of products, such as cosmetic products, hair care products, clothing, etc. that are offered by any number of retailers or distributors. The information or data in the content offerings database 132 and the product data database 134 can include metadata or have data categorized in a manner to identify data as belonging to exclusive sets of products as may be determined based on extrinsic properties of the products. Such extrinsic properties include a value or price of the products.

The user data database 136 includes information about user profiles per user, for example, historical purchase information, shipping information, age, preferences, goals, navigation history, etc. Each user can set permissions in the user data database 136 to enable access to the user data.

The electronic content offering platform 130 also includes a tiers of content generator 138, which has access to or receives information from the content offerings database 132 and the product data database 134 to receive a list of content. The tiers of content generator 138 is configured to divide content of the list of content into a normal set and an exclusive set based on either extrinsic properties of the content or based on instructions received from suppliers of the content. Next, the tiers of content generator 138 ranks content of the normal set based on a user preference vector that is determined according to data available per user accounts via access to the user data database 136 that is indicative of prior consumption of related content. Following, the tiers of content generator 138 creates a prioritized list of tiers of content, and each tier includes a plurality of nodes populated with content from the ranked normal set at positions of the plurality of nodes dynamically determined per the user accounts and with content from the exclusive set at a static position. Each tier of content is then set for publication.

The electronic content offering platform 130 further includes a graphical user interface (GUI) 140 that allows users to interact with the client devices 102 and 104 through graphical icons and audio indicators, typed command labels or text navigation. The GUI 140 includes interactive elements selectable for providing input by a user or receiving outputs by the GUI 140. The GUI 140 operates to provide information as received from the tiers of content generator 138 executable to generate an interactive graphical representation of information related to the merchandise information. For example, the GUI 140 is configured to publish the prioritized list of tiers of content to the network and restrict access to certain tiers of the prioritized list of tiers of content.

In operation, the GUI 140 further receive, from the client devices 102 and 104, a selection of a first content from a first tier, and the first tier is an unrestricted tier and the selection is associated with a first user account. The electronic content offering platform 130 also includes a social media tracking module 142 to determine an amount of social media activity over the network that is associated with the first content and is attributed to the first user account. The electronic content offering platform 130 also includes a social engagement factor (SEF)/score module 144 to determine or calculate a social engagement factor (SEF) for the first user account based on the amount of social media activity. The SEF/score module 144 is in communication with the tiers of content generator 138 so that based on the SEF for the first user account, such as once the SEF exceeds a thresholds, the tiers of content generator 138 electronically enables access at the server to a higher priority tier of the prioritized list of tiers of content for the first user account via the GUI 140.

The electronic content offering platform 130 further includes an input/output (I/O) system 1448 that couples components of the electronic content offering platform 130 to input and output devices of any type. For example, for components of the electronic content offering platform 130 that are instantiated at one of the client devices 102 and 104, the I/O system 148 couples to a touch screen display device through which outputs are displayed and user inputs (e.g., touch gestures) are received, and/or a network device through which data is transmitted/received over the network 108. Similarly, for components of the electronic content offering platform 130 that are instantiated at the host server device(s) 106, the I/O system 148 couples to a network device through which data is transmitted/received over the network 108.

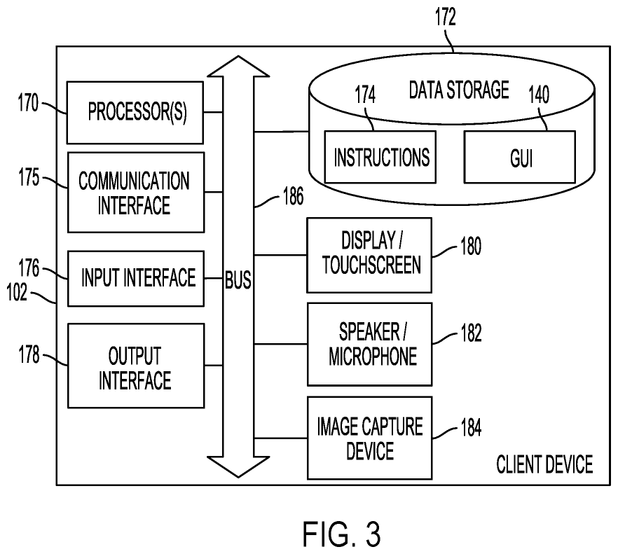

FIG. 3 illustrates a simplified block diagram of the client device 102, according to an example implementation. FIG. 3 does not necessarily show all of the hardware and software modules included in the client device 102, and omits physical and logical connections that will be apparent to one of ordinary skill in the art after review of the present disclosure. Although FIG. 3 illustrates components for the client device 102, the features shown in FIG. 3 are illustrative as components of any client device for use in the networked computer system 100.

The client device 102 includes one or more processor(s) 170, and a non-transitory computer-readable media (data storage) 172 storing instructions 174, which when executed by the one or more processor(s) 170, causes the client device 102 to perform functions (as described herein). To perform functions, the client device 102 includes a communication interface 175, an input interface 176, an output interface 178, a display/touchscreen 180, a speaker/microphone 182, and an image capture device 184, and each component of the client device 102 is connected to a communication bus 186. The client device 102 may also include hardware to enable communication within the client device 102 and between the client device 102 and other devices (not shown). The hardware may include transmitters, receivers, and antennas, for example.

The communication interface 175 is a wireless interface and/or one or more wireline interfaces that allow for both short-range communication and long-range communication to one or more networks or to one or more remote devices. Such wireless interfaces provide for communication under one or more wireless communication protocols, Bluetooth, WiFi (e.g., an institute of electrical and electronic engineers (IEEE) 802.11 protocol), Long-Term Evolution (LTE), cellular communications, near-field communication (NFC), and/or other wireless communication protocols. Such wireline interfaces include an Ethernet interface, a Universal Serial Bus (USB) interface, or similar interface to communicate via a wire, a twisted pair of wires, a coaxial cable, an optical link, a fiber-optic link, or other physical connection to a wireline network. Thus, the communication interface 175 is configured to receive input data from one or more devices, and configured to send output data to other devices.

The data storage 172 includes or takes the form of memory, such as one or more computer-readable storage media that can be read or accessed by the one or more processor(s) 170. The computer-readable storage media can include volatile and/or non-volatile storage components, such as optical, magnetic, organic or other memory or disc storage, which can be integrated in whole or in part with the one or more processor(s) 170. The non-transitory data storage 172 is considered non-transitory computer readable media. In some examples, the non-transitory data storage 172 can be implemented using a single physical device (e.g., one optical, magnetic, organic or other memory or disc storage unit), while in other examples, the non-transitory data storage 172 can be implemented using two or more physical devices. The non-transitory data storage 172 thus is a computer readable medium, and instructions 174 are stored thereon. The instructions 174 include computer executable code. The data storage 172 further stores information executable by the processor(s) 170 to perform functions of the GUI 140, for example.

The one or more processor(s) 170 is a general-purpose processor or special purpose processor (e.g., digital signal processors, application specific integrated circuits, etc.). The one or more processor(s) 170 receives inputs from the communication interface 175 as well as from other components (the display/touchscreen 180, the speaker/microphone 182, or the image capture device 184), and processes the inputs to generate outputs that are stored in the non-transitory data storage 172. The one or more processor(s) 170 can be configured to execute the instructions 174 (e.g., computer-readable program instructions) that are stored in the non-transitory data storage 172 and are executable to provide the functionality of the client device 102 described herein.

The input interface 176 is used to enter data or commands and can include, for example, a keyboard, a scanner, a user pointing device such as, for example, a mouse, a trackball, or a touch pad, or may further include the touchscreen or microphone.

The output interface 178 outputs information for reporting or storage, and thus, the output interface 178 may be similar to the communication interface 175 and can be a wireless interface (e.g., transmitter) or a wired interface as well.

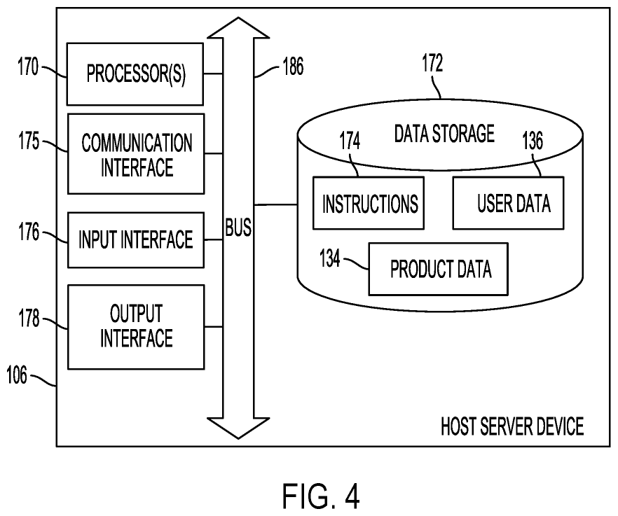

FIG. 4 illustrates a simplified block diagram of the host server device 106, according to an example implementation. Like the illustration in FIG. 3, FIG. 4 does not necessarily show all of the hardware and software modules included in the host server device 106. Further, similar components illustrated in FIG. 4 that have been described with reference to FIGS. 2-3 are not repeated here.

The host server device 106 can take the form of a server computer, a client computer, a personal computer (PC), a user device, a tablet, a laptop computer, a set-top box (STB), a personal digital assistant (PDA), a thin-client device, or any machine capable of executing a set of instructions (sequential or otherwise) that specify actions to be taken by that machine.

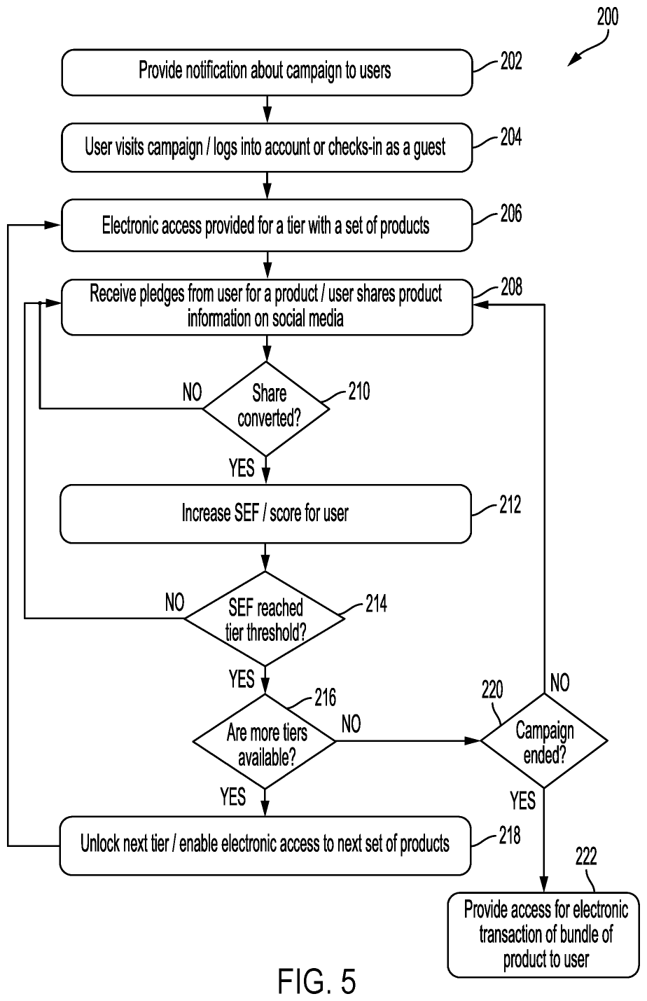

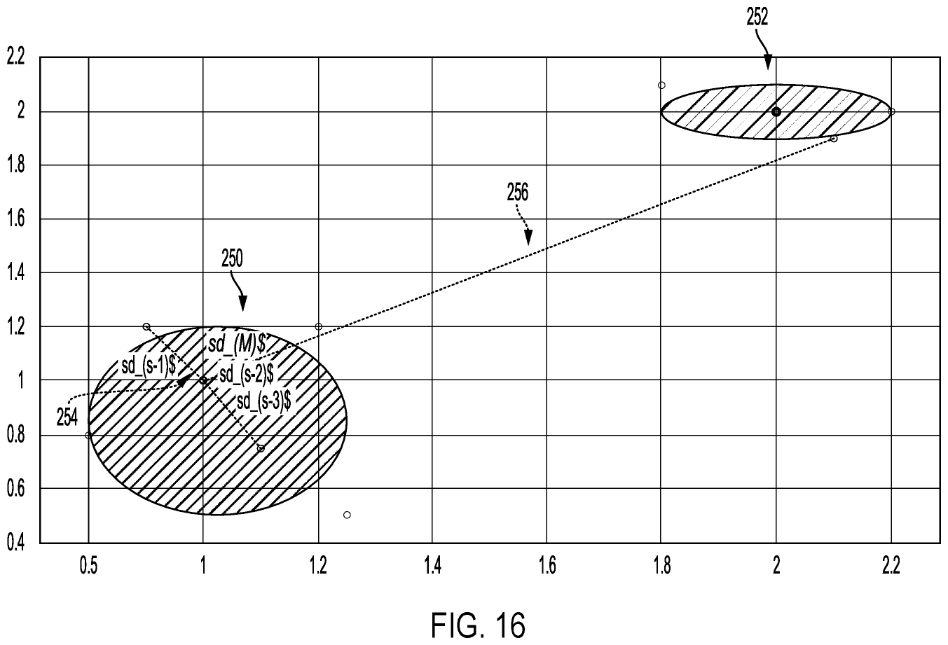

Within one example, in operation, when the instructions 174 are executed by the one or more processor(s) 170 (of the client device 102 or in other examples of the host server device 106, or still in other examples of a combination of the client device 102 and the host server device 106), the one or more processor(s) 170 is caused to perform functions for enabling electronic access to electronic content offerings over a network, as described herein, and specifics examples are further described with reference to flowcharts in FIGS. 5 and 16.

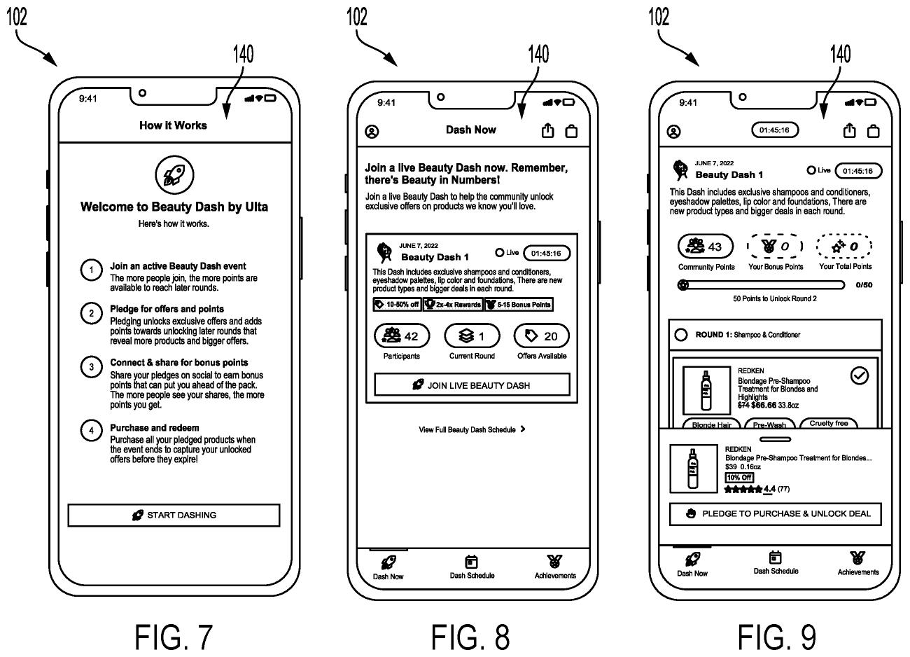

FIG. 5 is a flowchart illustrating an example of a computer-implemented method 200 for enabling electronic access to electronic content offerings over a network, according to an example implementation. Method 200 shown in FIG. 5 presents an example of a method that could be used with or provided by the networked computer system 100, the client devices 102 and 104, and/or the host server device(s) 106 shown in FIG. 1 or with the electronic content offerings platform 130 shown in FIG. 2, for example. Method 200 also presents an example of functions to be performed to generate outputs for display by the GUI 140, with specific examples shown in FIGS. 7-15, for example.

Within examples, devices or systems described herein are used or configured to perform logical functions presented in FIG. 5. In some instances, components of the devices and/or systems are configured to perform the functions such that the components are actually configured and structured (with hardware and/or software) to enable such performance. In other examples, components of the devices and/or systems are arranged to be adapted to, capable of, or suited for performing the functions, such as when operated in a specific manner. Method 200 includes one or more operations, functions, or actions as illustrated by one or more of blocks 202-222. Although the blocks are illustrated in a sequential order, these blocks may also be performed in parallel, and/or in a different order than those described herein. In addition, the various blocks may be combined into fewer blocks, divided into additional blocks, and/or removed based upon the desired implementation.

It should be understood that for this and other processes and methods disclosed herein, flowcharts show functionality and operation of one possible implementation of present examples. In this regard, each block or portions of each block may represent a module, a segment, or a portion of program code, which includes one or more instructions executable by a processor for implementing specific logical functions or steps in the process. The program code may be stored on any type of computer readable medium or data storage, for example, such as a storage device including a disk or hard drive. Further, the program code can be encoded on a computer-readable storage media in a machine-readable format, or on other non-transitory media or articles of manufacture. The computer readable medium includes non-transitory computer readable medium or memory, for example, such as computer-readable media that stores data for short periods of time like register memory, processor cache and Random Access Memory (RAM). The computer readable medium additionally or alternatively includes non-transitory media, such as secondary or persistent long-term storage, like read only memory (ROM), optical or magnetic disks, compact-disc read only memory (CD-ROM), for example. The computer readable media may also be any other volatile or non-volatile storage systems. The computer readable medium may be considered a tangible computer readable storage medium, for example.

In addition, each block or portions of each block in FIG. 5, and within other processes and methods disclosed herein, may represent circuitry that is wired to perform the specific logical functions in the process. Alternative implementations are included within the scope of the examples of the present disclosure in which functions may be executed out of order from that shown or discussed, including substantially concurrent or in reverse order, depending on the functionality involved, as would be understood by those reasonably skilled in the art.

The method 200 shown in FIG. 5 includes functionality for a gamified electronic access experience where users can gain access to a complete bundle of products in a tier-by-tier basis, and then be provided with an opportunity to purchase the products. At block 202, the method 200 includes the server device 106 providing notification about a campaign to users. At block 204, the method 200 includes allowing electronic access to the campaign such that a user visits the campaign and logs into a user account or checks-in as a guest. The campaign is provided for display by the GUI 140, and the user accesses the campaign through a web browser, for example.

Once the user visits the campaign page, the user can interact with the campaign without logging in. However, to experience full personalization, users will be prompted to login/create profile. On an initial visit to the campaign, to enable customization, users will be presented with a simple quiz where users can specify what type of products are of interest (e.g., shampoos, fragrances, paraben-free, sandalwood, etc.). If the quiz is skipped, existing information is used to curate a set of products provided for the user. In addition, if the user has an existing profile, existing information of the user is used to curate a set of products provided for the user in a customized campaign. Based on the information of the user/customer, a preferences vector is created and used to create the customized campaign. The user can then be shown a collection of personalized products in which the user can subscribe (or pledge) to participate in the campaign.

The campaign includes electronic content offerings, which may include products, layered into T number of prioritized tiers, and tiers can be unlocked based on an accumulated SEF score (on a per-user basis). Users can pledge to acquire or purchase one item in each tier (once the user successfully unlocks the tier) and can check out their basket at the end of a campaign. An underlying premise of the method 200 is to create virtual events/promotions that allow customers to select products of interest and promote the event/products with others or among their micro-communities. The social engagement in promoting the event/product is scored for every user and awards, such as products discounts, are given to the users for the products. A purpose of the method 200 is to incentivize user engagement and social sharing of the electronic content offerings.

Next, at block 206, the method 200 includes the server providing electronic access for a tier with a set of products in the campaign. For example, at the start of the campaign, the set of products shown to the user and for which the user has electronic access is tier 1 or a base level. Progressing to higher tier levels enables a user to have electronic access to acquire or order products of higher value or higher discounts.

The server will receive sets of products from vendors to be added to the campaign. The server classifies selected products to different levels or tiers based on factors, such as retail price, sales popularity of the product, stock availability, and demand for the product, for example. Lower tiers generally will contain moderately desired products with moderate discounts, and higher tiers may contain more products of higher quality or higher desirability with aggressive discounts. In addition, the vendor is able tune/overrule a classification or provide a rules-based classification for use on products.

Next, at block 208, the method 200 includes the server receiving pledges from the user for a product, and the user shares product information on social media. Once the user decided to pledge for a product, a main task of the user is to promote the campaign in order to unlock electronic access to higher tiers. The campaign is promoted by sharing a promotion link associated with the product through social channels, for example. An action of social engagement is tracked as a metric referred to as the social engagement factor (SEF). Every “share” posted on a social channel can be tracked.

A user may only pledge for one product in each tier. Pledging for a product accumulates points, and sharing product information through social media accumulates an SEF. A score is determine by multiplying points by the SEF. Thus, at block 210, the method 200 includes determining whether a share is converted. If not, the method 200 returns to block 208 and the user continues to share product information through social media to accumulate an SEF. If a share is converted, such as by another user accessing the shared promotion link, the method 200 continues to block 212 where the SEF is further increased thus increasing the score for the user. The SEF thus factors in a user's activity in sharing the campaign in social media, and how many campaign shares have been converted. A higher SEF and score enables the user to have electronic access to higher tiers. An example calculation of the SEF can be performed according to Equation [1] shown below.

At block 214, the method includes determining if the SEF has reached a tier threshold. If not, the method 200 returns to block 208 and the user continues to share product information through social media to accumulate an SEF. If the SEF has reached a tier threshold, the method 200 continues to block 216 to determine if more tiers are available. When more tiers are available, the method 200 continues to block 218 to unlock a next tier and enable electronic access to a next set of products. If no more tiers are available, the method 200 continues to block 220 to determine if the campaign has ended. If the campaign has not ended, the method 200 returns to block 208 and the user continues to share product information through social media to accumulate an SEF. If the campaign has ended, the method 200 continues to block 222 to provided access for electronic transaction of the selected bundle of products to the user.

The method 200 provides a technical solution to a technical problem of enabling electronic access to content offerings, such as products, over a network in a restricted manner. In some examples, users are interested in obtaining a best or lowest retail price on a product. However, in other examples, users are interested in obtaining access to more desirable or rare products. The method 200 enables functions for personalizing electronic access per user based on the user's participation and activity in a context of social media sharing. The method 200 also enables the server to create customized listings of products that are personalized per user, and adjusted dynamically in real-time as described below.

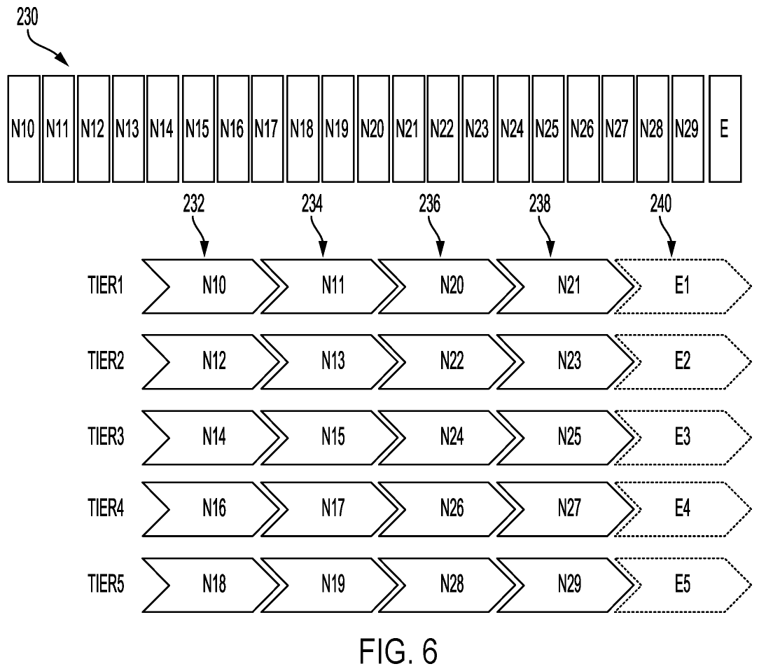

FIG. 6 conceptually illustrates an example of creation of tiers of products, according to an example implementation. A vendor will provide a set of products, a number of tier levels associated with the campaign, and a time limit for the campaign to run. In addition, products can be categorized or marked “normal” and “exclusive”, or the server can divide products of the list of products into a normal set and an exclusive set based on extrinsic properties of the products (e.g., rarity of products, retail price of products, etc.).

In an example shown in FIG. 6, a collection (K) of products is provided that will be added to the campaign. For example, K set of products, where K=25, may include=[Lipstick, Mascara, eye palette, concealer, primer, cleanser, moisturizer, serum, sunscreen, eye concentrate, conditioner, bonding oil, hair color, detangler, toning device, foundation brush, hair remover, curling iron, nylon elastics, shampoo, cleansing spray, perfume, hair spray, hair gel, lotion]. Of these products, E set of exclusive products, where E=5, is separated and E set of products includes=[sunscreen, Lipstick, hair remover, toning device, perfume].

The server then ranks remaining products (N=20) of the set K based on a user preference vector, which is determined according to data available per user accounts that is indicative of prior consumption of related content. For example, referencing a user account can determine historical purchases of specific brands/types of shampoo, and when such brands/types match to any being offered in the campaign, the campaign offering will be ranked as more relevant to that user. Thus, ranking of products is performed per user and thus varies per user. Ranking of products is also dynamic taking into account real time information of a user account related to past purchases, or other prior consumption of related content. Specifically, as the content offerings differ, prior consumption can differ as well. When the content offering is a promotion or discount available, the prior consumption considered can be usage of similar discounts by the user. Similarly, when the content offering is access to data of an electronic database, the prior consumption considered can be whether the user has previously logged-into and accessed the same or similar electronic databases to download data.

The ranking of products can be performed to generate any number of categories based on a number of products K in the collection. For K=N+E=25, for example, where N=20, products can be ranked into two categories (N1) and (N2), where N1 includes the 10 most relevant products and N2 includes the 10 least relevant products for a specific user. Thus, once the products are ranked, the listing of products is divided into two sets, and sorted into an ascending order of products making the last items most desirable/preferred.

An example ranking may result in the collection of products K divided as follows:
N1=[Mascara, eye palette, concealer, serum, eye concentrate, hair color, detangler, nylon elastics, shampoo, hair gel,]
N2=[primer, cleanser, moisturizer, conditioner, bonding oil, foundation brush, curling iron, cleansing spray, hair spray, lotion].

The server then creates a prioritized list of tiers of content, and each tier includes a plurality of nodes populated with content from the ranked normal set (N1 and N2) at positions of the plurality of nodes dynamically determined per the user accounts and with content from the exclusive set (E) at a static position. To do so, the server creates data structures representing each tier, and the data structure is established with nodes that have dynamic positions and static positions.

FIG. 6 illustrates a ranked listing 230 of the normal set (N1 and N2) with rankings labeled in sequential order from N10, N11, . . . , to N28, N29. With K=25, and five products per tier, five tiers are created. FIG. 6 illustrates a data structure for each tier as including node positions 232, 234, 236, and 238 to be populated with products from the normal set dynamically, and node position 240 to be populated with a product from the exclusive set. The nodes positions 232, 234, 236, and 238 are populated in a dynamic manner by taking into account each preference vector for each user. However, the node position 240 is static and will be populated with the same product in each tier for each user.

In one example, tier generation for Tier 1 will populate the first two node positions 232 and 234 with the first two products in the ranked listing 230 corresponding to the first two products in N1, and then populate the next two node positions 236 and 238 with the first two products in N2 in order to create a tier that has products deemed both relevant (e.g., highly relevant) and not relevant (e.g., less relevant) for the user. This process continues to generate Tiers 2-5 by distributing (highly) relevant and (less) relevant products evenly across all tiers. In this example distribution, few low-ranked products from the set N1 and few low-ranked products from the set N2 would jointly be included in Tier 1. Likewise, for a last tier, most desirable products of the set N1 and N2 would be included. The last tier may represent both relevant and balanced products per user.

Each tier then includes one product in node position 240 from the exclusive set, and the node position 240 is static, and the selection of a product from the exclusive set is performed according to a set of rules that include prioritized rankings of the products for least exclusive item to be in Tier 1 and most exclusive item to be in Tier 5.

Distribution of products across the tiers in the manner shown in FIG. 6 is performed to encourage completion of requirements (e.g., meet social media activity thresholds) to unlock tiers in order to gain electronic access to all desirable products.

Using the example collection of products K above, Tiers 1-5 are generated as follows:
Tier1=[mascara, eye palette, primer, cleanser, sunscreen]
Tier2=[concealer, serum, moisturizer, conditioner, Lipstick]
Tier3=[eye concentrate, hair color, bonding oil, foundation brush, hair remover]
Tier4=[detangler, nylon elastics, curling iron, cleansing spray, toning device]
Tier5=[shampoo, hair gel, hair spray, lotion, perfume]

Each tier of products is then provided to the GUI 140 to be published for viewing by the user, and each tier includes many products visible to the user. In some examples, the server publishes the tiers to the GUI 140, however, the user is only able to view unrestricted tiers or simply the existence of the tiers but not the items in the restricted tiers. Some tiers can also include product-placeholders to illustrate a mystery product that is included in the tier but not visible to the user, such as products in node position 238, for example. Mystery products in a tier can be unlocked as well. The server thus can restrict electronic access to tiers or to products in tiers, and the restriction can include either or both of restriction to viewing the data or restriction to gaining access for purchase.

Initially, the server provides electronic access to products in Tier 1 for all users. To gain access to products of higher tiers, a user is required to perform social engagement functionality that is tracked by the server resulting in calculation of a score that is based on the SEF metric. The SEF metric can be based on how many times a user shares information about products or other content offerings for which the user has pledged in a tier via social media channels. To do so, the server can utilize APIs called to determine how a customer arrived at a webpage, such as whether a customer arrived by using a promotion link shared by the user. For other social media, software applications include plug-ins that track a number of “shares” of information via the social media app and the server can receive outputs from the plug-ins with information indicating a number of shares. The SEF metric can further take into account views of posts resulting in “impressions” so that the more a user shares, and the more users that view the share, the higher the SEF will grow.

A score is then calculated as a number of accumulated points by the user multiplied by the SEF. A user can acquire points by pledging products, such as one point per pledge. In another example, points are globally distributed, such that each user receive points per pledge equal to a number of pledges received for the product. Thus, when forty-two users pledge a product, each user is awarded forty-two points. As more users pledge the product, base points awarded to the users that pledge the product increase as well. Finally, for a user with an SEF of two and point total of forty-two, a score is calculated as 2×42=84. If the score threshold to reach Tier 2 is fifty, then the server will unlock Tier 2 for the user and provide electronic access to the products in Tier 2.

In operation, the server maps a pledge received by the user for a product to a node of the data structure in order to monitor points to be awarded based on received pledges from all users accessing the campaign.

Similarly, the server monitors and tracks the SEF per user over time. An SEF for a user is accumulative and dynamic or time-bound. The server accumulates shares to increase an SEF, however, shares expire based on pre-set time limits. When a share expires, the SEF decreases. The SEF for each user thus changes over time during the campaign, and carries forward to subsequent campaigns as well.

FIGS. 7-15 are example screenshots of the GUI 140 on the client device 102 operated for functionality of the electronic content offering platform 130, according to example implementations. Initially, as shown in FIG. 7, the server 106 sends a notification to the client device 102 to indicate that a new campaign started. The notification may be sent by text message (e.g., short message server (SMS)) or via a message in a dedicated software application.

As shown in FIG. 8, the electronic content offering platform 130 provides information of the campaign, titled “Beauty Dash 1” in this example, displayed on the GUI 140. The information indicates a number of current participants, content offerings available (e.g., 20), and time remaining on the campaign (e.g., 01:45:16), for example.

Upon joining the live campaign, the server 106 then ranks products based on best-to-worst fit for that user. For example, the server 106 ranks content of the normal set based on a user preference vector by accessing a profile of the user. For this example, the campaign has K=25 products that are ranked and categorized into T=5 tiers with five products in each tier so as to customize a division of the products across the tiers for the user. The server 106 sets a score threshold of 50 points to reach tier 2 and be granted electronic access to content offerings of tier 2. The user in this example is the 43nd person to participate.

As shown in FIG. 9, after joining the campaign, the server 106 publishes the content offerings of tier 1 to the GUI 140 for display. In this example, the user can now view all products in tier 1, which includes shampoo in this example.

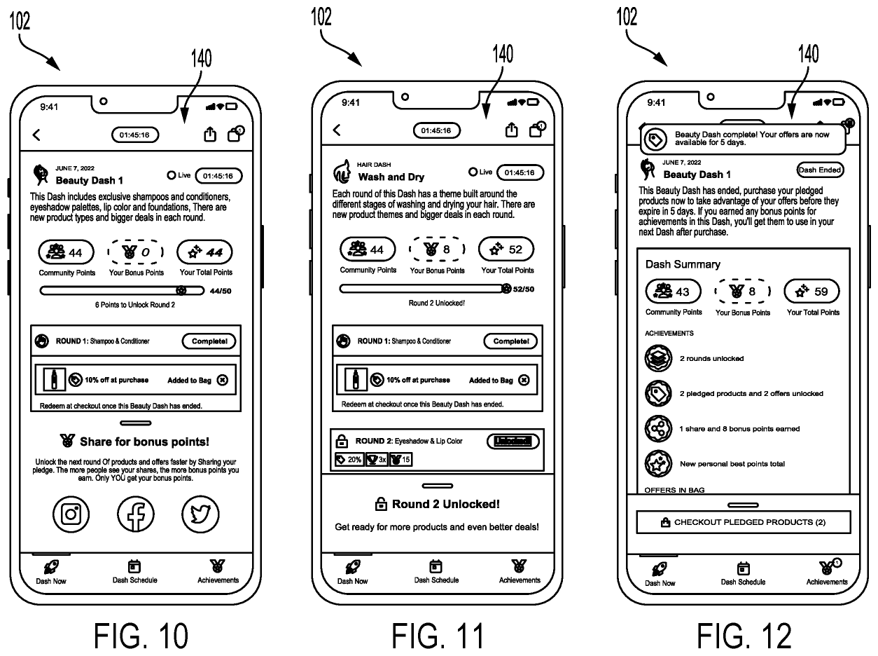

As shown in FIG. 10, the user pledges to purchase the shampoo, and thus, the server 106 receives, from the client device 102 accessing the server 106 over the network 108, a selection of the shampoo from the first tier. After pledging the product, the server 106 awards 44 points to the user, which is determined by the number of participants who pledged this product (e.g., and is a running total). In FIG. 10, the GUI 140 next displays a window enabling the user to share content, via social media channels, to increase a score total.

In this example, the user shares the product from the campaign on all the social media channels. In FIG. 11, upon sharing the product, the server 106 awards bonus points to the user account, and the threshold point total for accessing tier 2 has been met. Thus, the server 106 unlocks tier 2 and electronically enables access to tier 2 for the user.

The server 106 then computes the SEF based on how many users receive/activate the share. For example, the server 106 determine the SEF specific for the user account based on an amount of social media activity over the network 108 that is associated with the pledged content and is attributed to the user account. In this example, assume for illustration that the SEF is calculated to be 2.0, and then the score point total would be updated to be (total points: 52)×(SEF: 2.0)=104.

As the number of pledges increases, the score point total also increases. As an example, at time to, assume 42 pledges, and SEF is 2.0, and score at that time is 84. Later, at t₁ if there are 70 pledges globally, but SEF is still 2.0, the score point total would increase to 140 points. A goal is to incentivize group actions by keeping maintaining points.

At any point in time, when a user's score hits the threshold designated for a tier unlock, the server 106 then provides electronic access to content offerings of the next tier. The campaign process continues until the last tier is unlocked or until expiration of time. As shown in FIG. 12, the campaign has ended and the server 106 prompts the user to checkout all pledged products.

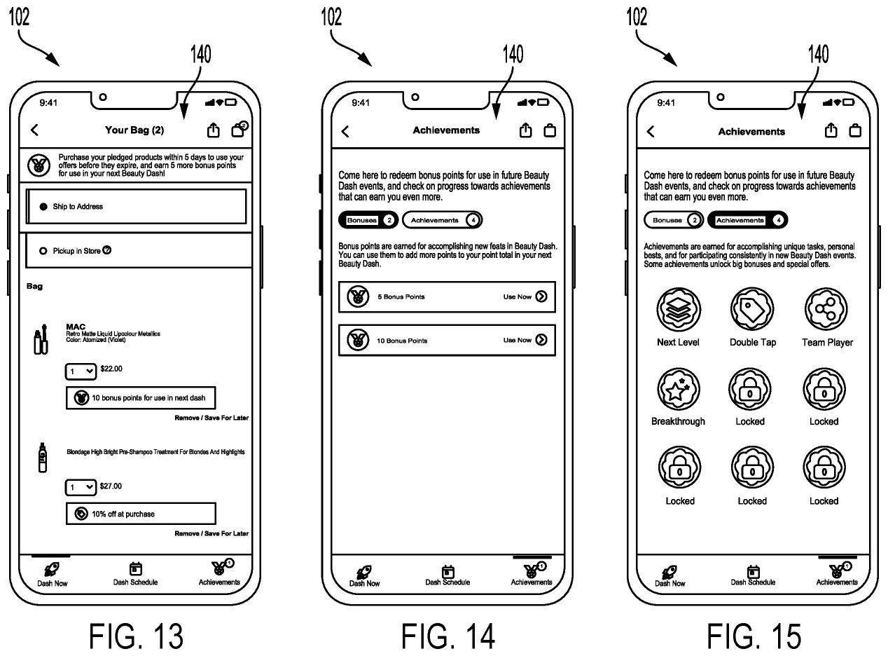

At FIG. 13, the server 106 illustrates all products pledged by the user on the GUI 140 and available for purchase via an electronic transaction.

At FIG. 14, the server 106 illustrates points awarded to the user as a result of the social media activity by the user. The server 106 maintains the SEF for the user and links the SEF to the user profile.

At FIG. 15, the server 106 illustrates achievements completed by the user for accomplishing certain tasks. Achievements can include any number of user activities and are accumulated over time and stored by the server 106. The server 106 may use achievements as another factor when determining the when to unlock a next tier and provide electronic access to new content offerings.

As described above, the process begins by the server 106 receiving a listing of content from a vendor, and the server 106 will then divide and rank the content dynamically per user to create the customized listing of tiers. For a more interactive customer engagement model, further customization of products per user can be performed to increase a probability that products offered to a user are tailored to the user as much as possible. In one example, this can be achieved through a concept of clustering where users with similar preferences (e.g., as determined by a beauty quiz, buying habits, and social media activities) are grouped together. If a user has a strong preference in buying a specific brand, based on available products in the received listing of products, the server 106 then offers such products to the user once pledge goals are reached.

As one example, the server 106 accesses the user profile to determine items that have been purchased and to identify other items that are alike based on category, labels, and other content-based features. Such content-based methods of suggestions can help ensure that items recommended are similar to items in a user's purchase history based on content descriptors. However, generating tiers in this manner can have a downside that the types of products provided to the user are reserved based on known content-descriptors, which can lead to the user potentially missing opportunities to expand awareness of wider content items.

Thus, the server 106 generates the tier listings by not constraining to only a limited set of products, but also including a variety of products taking into account browse history of the user. Given a set of products, a user preference vector is determined that can be defined with parameters for type of products, category of products, brands of products, etc., and the preference vector is dynamically adapted to over time.

As a number of users grow in volume, different subgroups of users sharing mutual interests emerge. Recognizing and understanding distinctive subgroups of customers or micro-communities can help identify deeper insights and patterns. Within examples, the SEF tracks relevancy among micro-communities and helps gauge individual campaign performance in the campaign, reward the loyal customers, and enables learning more about user interests and what influences user's decisions. This information allows business departments to craft more personalized and relevant marketing experiences.

Micro-communities can be seen as clusters with several nodes and patterns are discovered when clusters are formed based on perceived similarity, defining commonalities that are inherent. Community detection is implemented by finding nodes with highest centrality and forming a community therefrom. Thus, micro-communities can be detected using different approaches, and in one example, a k-means clustering technique can be used for building the micro-communities. K-means is centroid/distance-based algorithm where a distance to a point to the cluster is calculated. An objective is to minimize a sum of distances between the points and their respective cluster centroid.

A cluster refers to a collection of data points pooled together due to similarities. In one example, a target number k, which refers to a number of centroids needed in a dataset of users, is defined. The centroid is an imaginary location representing the center of the cluster. Every data point is allocated to each of the clusters through a cluster sum of squares. The formed cluster is a sub-graph of a social network whose nodes have approximated similar interests or similar purchase history. Hence, the micro-communities building can help with relationship determination between nodes in the network. Centroids can be seen as influential nodes.

Following engagement measurement provides a sense of how the content is performing and what content to focus on within next campaigns to expand reach and spark interest in the tiers in the campaigns. To measure SEF by social media activity, the following equation is developed. For cluster of interest cₖ, collection of users P and collection of shares S:

$$S E F = {\sum }_{s ∈ S} ( 1 - α \frac{{d}_{s}}{{d}_{M}} ) , \qquad Equation [ 1 ]$$

$$where αϵ [ 0 , 1 ] and {d}_{M} = {max}_{{p}_{i} ϵ P} \{ d ( {c}_{k} , {p}_{i} ) \}$$

For α=0, shares are counted with no relevancy element. For α=1, shares are counted toward relevancy with max importance.

Within examples, a higher SEF is generated for users sharing with other users a the same affinity cluster or close to the center of the cluster. A maximum distance in the space between the centroid of one cluster and every single individual that mapped is determined to provide a max distance d_{M}, which is used to normalize a distance of each of the shares or each of the users to which content has been shared.

As a user being shared to is closer and closer to the centroid, the

$$α \frac{{d}_{s}}{{d}_{M}}$$

term drops to almost zero and one point is added for each of the shares. If α=1, this max term starts to tend toward the maximum,

$$α \frac{{d}_{s}}{{d}_{M}} ,$$

which goes to one and makes the entire absolute value go to zero and SEF will fall to zero. In an extreme case, where a user only shared to extreme far individuals in the whole space, this can be the result. The α parameter can be tuned to give weight/depth to the relevancy part of the share.

FIG. 16 is an example graph illustrating dynamics between two affinity clusters, according to an example implementation. The diagram in FIG. 16 considers a hair cluster 250 and a fragrance cluster 252 as an example, which represents clusters of users with an affinity to hair care products and fragrance products. In the graph, line 254 represents distance between users with similar affinities in hair products, and line 256 represents distance between users with affinities in hair products to fragrance products. In this example, the line 254 has a shorter distance due to more similarities of the compared products.

The SEF can be calculated to take into account the affinities shown in FIG. 16. Once the SEF is calculated, within some examples, determining when users stop engaging with the campaign is utilized to modify the SEF. A way to bias the SEF for non-influencers is to introduce a normal distribution so that the share influence declines after reaching a threshold. In this example, bulk sharing in a community can be normalized to have a less aggressive boost to the SEF when compared to regular user activity.

To extend functionality into the SEF, a time component can be added to the existing equation. SEF scores thus would contain a level of volatility. A rate of engagement for a particular user is materialized in the form of how many shares are being engaged by other users, and whether those shares translate into sales. In the same manner, SEF can begin to deplete if the user engagement is low during the campaign. Such a methodology encourages users to share in a more organic manner as opposed to attempting to perform bulk sharing at a beginning of the campaign. Depletion is factored into the SEF as a decay function, within examples.

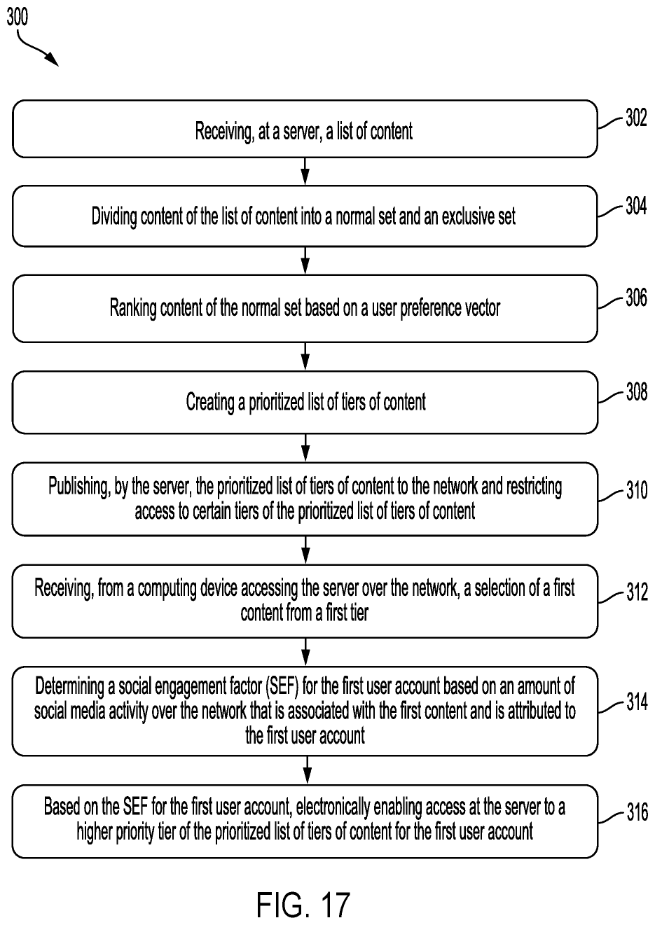

FIG. 17 is a flowchart illustrating another example of a computer-implemented method 300 for enabling electronic access to electronic content offerings over a network, according to an example implementation. Method 300 shown in FIG. 17 presents an example of a method that could be used with or performed by the networked computer system 100, the client devices 102 and 104, and/or the host server device(s) 106 shown in FIG. 1 or with the virtual signage platform 130 shown in FIGS. 2-4, for example. Method 300 also presents an example of functions to be performed to generate outputs for display by the GUI 140, as shown in FIG. 11, for example.

At block 302, the method 300 includes receiving, at a server, a list of content.

At block 304, the method 300 includes dividing content of the list of content into a normal set and an exclusive set.

At block 306, the method 300 includes ranking content of the normal set based on a user preference vector. The user preference vector is determined according to data available per user accounts that is indicative of prior consumption of related content.

At block 308, the method 300 includes creating a prioritized list of tiers of content. Each tier includes a plurality of nodes populated with content from the ranked normal set at positions of the plurality of nodes dynamically determined per the user accounts and with content from the exclusive set at a static position. In one example, the server 106 create the prioritized list of tiers of content by distributing content from the ranked normal set into the plurality of nodes per tier such that each tier is populated with both high ranking content and low ranking content.

At block 310, the method 300 includes publishing, by the server, the prioritized list of tiers of content to the network and restricting access to certain tiers of the prioritized list of tiers of content.

At block 312, the method 300 includes receiving, from a computing device accessing the server over the network, a selection of a first content from a first tier, wherein the first tier is an unrestricted tier and the selection is associated with a first user account.

At block 314, the method 300 includes determining a social engagement factor (SEF) for the first user account based on an amount of social media activity over the network that is associated with the first content and is attributed to the first user account.

In examples, the server 106 determines the SEF for the first user account by determining an amount of sharing a network link associated with the first content over the network, or by accessing social media monitoring software to analyze social media posts associated with a social media account linked to the first user account. In another example, the server determines the SEF for the first user account by accumulating the amount of social media activity over the network over time that is associated with the first content and is attributed to the first user account, and the SEF varies over time based on the amount of social media activity.

At block 316, the method 300 includes based on the SEF for the first user account, electronically enabling access at the server to a higher priority tier of the prioritized list of tiers of content for the first user account. Within examples, the server unlocks access to the data content enabling a user to select items from the next tier and have access to the data content.

In one example, the method 300 determines when to enable access at the server to the higher priority tier based on a score, and the score is calculated using the SEF metric. For instance, the method 300 optionally includes assigning a point total for the first user account based on a number of selections of the first content from the first tier by all the user accounts, determining a score for the first user account based on the point total multiplied by the SEF, and then electronically enabling access at the server to the higher priority tier of the prioritized list of tiers of content for the first user account by determining that the score for the first user account is above a threshold and based on determining that the score for the first user account is above the threshold, electronically enabling access at the server to the higher priority tier of the prioritized list of tiers of content for the first user account.

The method 300 optionally includes electronically enabling access at the server to subsequent higher priority tiers of the prioritized list of tiers of content for the first user account, in a serial manner, based on the SEF for the first user account satisfying a threshold for the amount of social media activity required for content selected in a respective tier and being attributed to the first user account.

Within further examples, the method 300 includes determining unselected content in the prioritized list of tiers of content, creating an updated prioritized list of tiers of content by removing at least some of the unselected content from some tiers of content, and republishing, by the server, the updated prioritized list of tiers of content. In this manner, items that are not selected are deemed undesired and can be replaced by items that are more desirable for use in future campaigns. Further, unselected content from the tiers of content can be utilized to further train and adjust the user preference vector.

In another example, content in the tiers can be modified in real-time. For instance, in one example, the method 300 includes based on the SEF for the first user account, modifying content included in the prioritized list of tiers of content that is accessible at the server by the first user account. In this manner, for users with a high SEF, such as above a set threshold, more data content offerings from the exclusive set can be included in the tiers so as to have multiple exclusive items per tier rather than only one exclusive item per tier.

Within examples, the method 300 concludes after expiration of a time period, and the server sends an electronic notification to the first user account indicating availability to execute an electronic transaction over the network for all selected content.

Example methods and systems described herein thus enable customized content offerings to be created and offered to specific users, and the users have options to choose one item from among a group of items for purchase. Following, based on electronic activities of the user via social media channels, the server will determine electronic access to additional groups of items for the user. The methods and systems create an interactive experience between the user and the content providers, which can lead to increased access to higher priority items.

Examples above describe implementations as methods performed by devices. In other examples, implementations take the form of a non-transitory computer-readable media having stored therein instructions, which when executed by a computing device having one or more processors causes the computing device to perform functions of the described methods.

Moreover, while some examples have been described in the context of fully functioning computers and computer systems, those skilled in the art will appreciate that various examples are capable of being distributed as a program product in a variety of forms, and that the disclosure applies equally regardless of a particular type of machine or computer-readable media used to effect the distribution. Thus, in further examples, implementations take the form of a system comprising a computing device comprising one or more processors and non-transitory computer-readable media having stored therein instructions, which when executed by the one or more processors, causes the computing device to perform functions of the described methods.

Further examples of machine-readable storage media, machine-readable media, or computer-readable (storage) media include, but are not limited to, recordable type media such as volatile and non-volatile memory devices, floppy and other removable drives, hard drives, thumb drives, optical disks (e.g., Compact Disk Read-Only Memory (CD ROM), Digital Versatile Disks, (DVDs), etc.), among others, and transmission type media such as digital and analog communication links.

Different examples of the system(s), device(s), and method(s) disclosed herein include a variety of components, features, and functionalities. It should be understood that the various examples of the system(s), device(s), and method(s) disclosed herein may include any of the components, features, and functionalities of any of the other examples of the system(s), device(s), and method(s) disclosed herein in any combination or any sub-combination, and all of such possibilities are intended to be within the scope of the disclosure.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples describe different advantages as compared to other advantageous examples. The example or examples selected are chosen and described to explain the principles of the examples, the practical application, and to enable others of ordinary skill in the art to understand the disclosure for various examples with various modifications as are suited to the particular use contemplated.

Having described the subject matter of the present disclosure in detail and by reference to specific examples thereof, it is noted that the various details disclosed herein should not be taken to imply that these details relate to elements that are essential components of the various examples described herein, even in cases where a particular element is illustrated in each of the drawings that accompany the present description. Further, it will be apparent that modifications and variations are possible without departing from the scope of the present disclosure, including, but not limited to, examples defined in the appended claims. More specifically, although some aspects of the present disclosure are identified herein as preferred or particularly advantageous, it is contemplated that the present disclosure is not necessarily limited to these aspects.

For the purposes of describing and defining examples herein, it is noted that terms “substantially” or “about” are utilized herein to represent an inherent degree of uncertainty attributed to any quantitative comparison, value, measurement, or other representation. The terms “substantially” and “about,” when utilized herein, represent the degree by which a quantitative representation may vary from a stated reference without resulting in a change in a basic function of the subject matter at issue.

What is claimed is:

1. A method of enabling electronic access to electronic content offerings over a network, comprising:
receiving, at a server, a list of content;
dividing content of the list of content into a normal set and an exclusive set;
ranking content of the normal set based on a user preference vector, wherein the user preference vector is determined according to data available per user accounts that is indicative of prior consumption of related content;
creating a prioritized list of tiers of content, wherein each tier includes a plurality of nodes populated with content from the ranked normal set at positions of the plurality of nodes dynamically determined per the user accounts and with content from the exclusive set at a static position;
publishing, by the server, the prioritized list of tiers of content to the network and restricting access to certain tiers of the prioritized list of tiers of content;
receiving, from a computing device accessing the server over the network, a selection of a first content from a first tier, wherein the first tier is an unrestricted tier and the selection is associated with a first user account;
determining a social engagement factor (SEF) for the first user account based on an amount of social media activity over the network that is associated with the first content and is attributed to the first user account; and
based on the SEF for the first user account, electronically enabling access at the server to a higher priority tier of the prioritized list of tiers of content for the first user account.

2. The method of claim 1, wherein creating the prioritized list of tiers of content comprises:
distributing content from the ranked normal set into the plurality of nodes per tier such that each tier is populated with both high ranking content and low ranking content.

3. The method of claim 1, wherein determining the SEF for the first user account based on the amount of social media activity over the network comprises determining an amount of sharing a network link associated with the first content over the network.

4. The method of claim 1, wherein determining the SEF for the first user account based on the amount of social media activity over the network comprises:
accessing social media monitoring software to analyze social media posts associated with a social media account linked to the first user account.

5. The method of claim 1, wherein determining the SEF for the first user account comprises:
determining the SEF for the first user account based on accumulating the amount of social media activity over the network over time that is associated with the first content and is attributed to the first user account, wherein the SEF varies over time based on the amount of social media activity.

6. The method of claim 1, wherein receiving the list of content comprises receiving a list including one or more of merchandise information, promotions, and discounts.

7. The method of claim 1, wherein receiving the list of content comprises receiving a list of products.

8. The method of claim 7, wherein the exclusive set is determined based on extrinsic properties of the products including a value of the products.

9. The method of claim 1, further comprising:
assigning a point total for the first user account based on a number of selections of the first content from the first tier by all the user accounts;
determining a score for the first user account based on the point total multiplied by the SEF; and
wherein electronically enabling access at the server to the higher priority tier of the prioritized list of tiers of content for the first user account comprises:
determining that the score for the first user account is above a threshold;
based on determining that the score for the first user account is above the threshold, electronically enabling access at the server to the higher priority tier of the prioritized list of tiers of content for the first user account.

10. The method of claim 1, further comprising:
based on the SEF for the first user account, modifying content included in the prioritized list of tiers of content that is accessible at the server by the first user account.

11. The method of claim 1, further comprising:
after expiration of a time period, the server sending an electronic notification to the first user account indicating availability to execute an electronic transaction over the network for all selected content.

12. The method of claim 1, further comprising:
electronically enabling access at the server to subsequent higher priority tiers of the prioritized list of tiers of content for the first user account, in a serial manner, based on the SEF for the first user account satisfying a threshold for the amount of social media activity required for content selected in a respective tier and being attributed to the first user account.

13. The method of claim 1, further comprising:
determining unselected content in the prioritized list of tiers of content;
creating an updated prioritized list of tiers of content by removing at least some of the unselected content from some tiers of content; and
republishing, by the server, the updated prioritized list of tiers of content.

14. A system comprising:
one or more processors and non-transitory computer-readable media having stored therein instructions, which when executed by the one or more processors, causes the system to perform functions comprising:
receiving a list of content;
dividing content of the list of content into a normal set and an exclusive set;
ranking content of the normal set based on a user preference vector, wherein the user preference vector is determined according to data available per user accounts that is indicative of prior consumption of related content;
creating a prioritized list of tiers of content, wherein each tier includes a plurality of nodes populated with content from the ranked normal set at positions of the plurality of nodes dynamically determined per the user accounts and with content from the exclusive set at a static position;
publishing the prioritized list of tiers of content to a network and restricting access to certain tiers of the prioritized list of tiers of content;
receiving, from a computing device accessing the system over the network, a selection of a first content from a first tier, wherein the first tier is an unrestricted tier and the selection is associated with a first user account;
determining a social engagement factor (SEF) for the first user account based on an amount of social media activity over the network that is associated with the first content and is attributed to the first user account; and
based on the SEF for the first user account, electronically enabling access at the system to a higher priority tier of the prioritized list of tiers of content for the first user account.

15. The system of claim 14, wherein the function of creating the prioritized list of tiers of content comprises:
distributing content from the ranked normal set into the plurality of nodes per tier such that each tier is populated with both high ranking content and low ranking content.

16. The system of claim 14, wherein the function of determining the SEF for the first user account comprises:
determining the SEF for the first user account based on accumulating the amount of social media activity over the network over time that is associated with the first content and is attributed to the first user account, wherein the SEF varies over time based on the amount of social media activity.

17. The system of claim 14, wherein the functions further comprise:
after expiration of a time period, the system sending an electronic notification to the first user account indicating availability to execute an electronic transaction over the network for all selected content.

18. A non-transitory computer-readable media having stored therein executable instructions, which when executed by a system one or more processors causes the system to perform functions comprising:
receiving a list of content;
dividing content of the list of content into a normal set and an exclusive set;
ranking content of the normal set based on a user preference vector, wherein the user preference vector is determined according to data available per user accounts that is indicative of prior consumption of related content;
creating a prioritized list of tiers of content, wherein each tier includes a plurality of nodes populated with content from the ranked normal set at positions of the plurality of nodes dynamically determined per the user accounts and with content from the exclusive set at a static position;
publishing the prioritized list of tiers of content to a network and restricting access to certain tiers of the prioritized list of tiers of content;
receiving, from a computing device accessing the system over the network, a selection of a first content from a first tier, wherein the first tier is an unrestricted tier and the selection is associated with a first user account;
determining a social engagement factor (SEF) for the first user account based on an amount of social media activity over the network that is associated with the first content and is attributed to the first user account; and
based on the SEF for the first user account, electronically enabling access at the system to a higher priority tier of the prioritized list of tiers of content for the first user account.

19. The non-transitory computer-readable media of claim 18, wherein the functions further comprise:
after expiration of a time period, the system sending an electronic notification to the first user account indicating availability to execute an electronic transaction over the network for all selected content.

20. The non-transitory computer-readable media of claim 18, wherein the functions further comprise:
electronically enabling access at the system to subsequent higher priority tiers of the prioritized list of tiers of content for the first user account, in a serial manner, based on the SEF for the first user account satisfying a threshold for the amount of social media activity required for content selected in a respective tier and being attributed to the first user account.
